(19) United States
(12) Patent Application Publication
(10) Pub. No.: US 2004/0118494 A1
(43) Pub. Date: Jun. 24, 2004

(54) Vehicle pneumatic tire

(75) Inventor: Werner Liederer, Hannover (DE)

Correspondence Address: GREENBLUM & BERNSTEIN, P.L.C., 1950 ROLAND CLARKE PLACE, RESTON, VA, 20191, US

(73) Assignee: Continental Aktiengesellschaft, Hannover (DE)

(21) Appl. No.: 10/733,314

(22) Filed: Dec. 12, 2003

(30) Foreign Application Priority Data
Dec. 20, 2002 (DE) 10259907.6

(51) Int. Cl. B60C 11/03; B60C 113/00

(52) U.S. Cl. 152/209.3; 156/110.1

(57) ABSTRACT

Vehicle tire includes a tread having a circumference, profile structures, and grooves. The grooves run at least one of generally diagonally into a central area of the tread and generally diagonally over a central area of the tread. The grooves and the profile structures form base pitches. The base pitches are arranged over the circumference and have a pitch sequence which minimized tire noise. At least two of the base pitches have different circumferential lengths. One of the at least two base pitches includes at least one profile structure. Another of the at least two base pitches includes at least two profile structures separated by at least one cross-groove. This Abstract is not intended to define the invention disclosed in the specification, nor intended to limit the scope of the invention in any way.

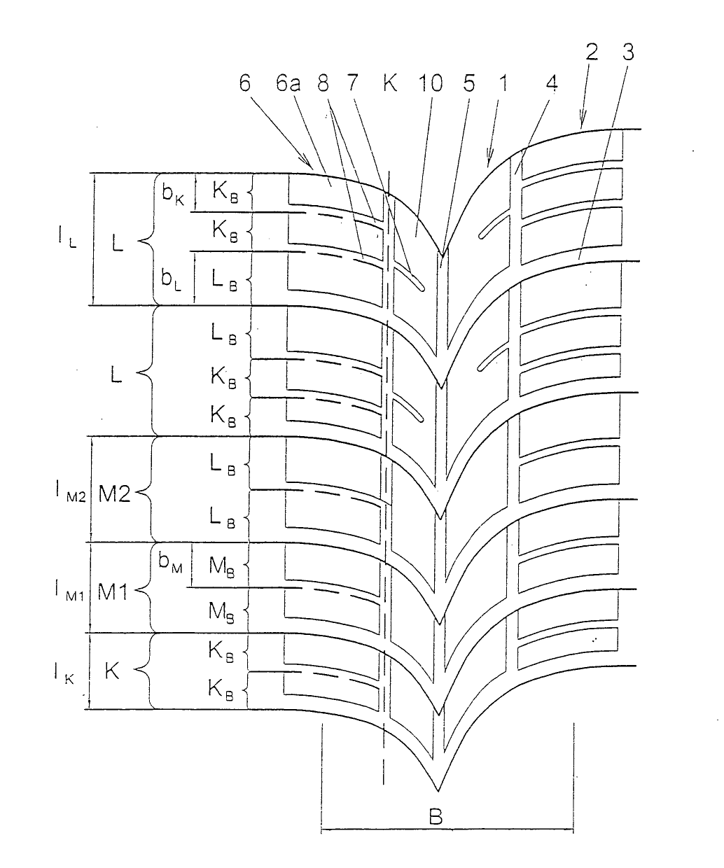

### CROSS-REFERENCE TO RELATED APPLICATIONS

The present application claims priority under 35 U.S.C. §119 of German Patent Application No. 102 59 907.6, filed on Dec. 20, 2002, the disclosure of which is expressly incorporated by reference herein in its entirety.

### BACKGROUND OF THE INVENTION

1. Field of the Invention

The invention relates to a vehicle pneumatic tire, in particular a radial tire, with a tread that is composed of profile positives (structures) that are structured by grooves running diagonally in or over the central area and by cross-grooves, whereby the grooves running diagonally together with the profile positives form base pitches with at least two different circumferential lengths, which are arranged over the tire circumference according to a pitch sequence in a noise-optimized manner.

2. Discussion of Background Information

In order to reduce tire/road noise, it is usual in tread design to assign different circumferential lengths to the pitches, the identical profile sections arranged one after the other over the tire circumference. Treads are thereby usually executed with pitches with two to five different circumferential lengths whose length ratio to one another is predetermined and whose most favorable succession, the pitch sequence, is determined by means of suitable computer programs.

In the patent literature there is a large number of proposed solutions on the subject of pitches and pitch sequences of treads. A vehicle pneumatic tire of the type referenced at the outset is known, for example, from EP-A-0 970 822. Here, starting from the shoulder block row, the pitch sequence is adjusted so that more than two pitches of identical length do not follow one another directly anywhere. The number of blocks in the shoulder block rows should thereby be twice or three times the number of blocks in the center block rows adjacent to the shoulder block rows. A more uniform abrasion pattern and at the same time a favorable effect on the tire/road noise should thus be achieved.

From EP-B-0 114 594 it is known to provide different pitch numbers in the two tread halves in order to favorably influence the tire/road noise.

In practice it has now emerged that the known subdivisions of the structure of a tread into pitches and the associated pitch sequences are still in need of improvement, in particular with regard to obtaining the most uniform possible abrasion and a further optimization of the tire/road noise.

### SUMMARY OF THE INVENTION

The invention therefore aims to improve a vehicle pneumatic tire or its tread in this respect.

Thus, the invention provides for a tire wherein, at least in one tread area running in the circumferential direction, the base pitches are subdivided by the cross-grooves into at least two different profile positive groups that are divided into other pitches, whereby at least one type of profile positive groups features at least one pitch more than the other or another type of profile positive groups.

Thus with a tread embodied according to the invention a further division into pitches occurs in one circumferential area. The base pitches are arranged over the tire circumference in the best possible manner, the other pitches can subsequently be optimized “thereto” whereby in this respect a plurality of possibilities is available. The invention therefore makes it possible to optimize a tread in terms of noise very well and at the same time to also take into account other tire properties, e.g., uniform abrasion.

In a preferred embodiment of the invention, the other pitches are arranged within their profile positive group according to a specific sequence. This is another measure for optimizing the arrangement of the pitches in order to reduce the tire/road noise.

In this connection it is further advantageous if the sequence of the other pitches within one type of profile positive group is adjusted to the sequence of the other pitches within the same and/or another type of a profile positive group.

In addition or alternatively, the pitch arrangement can be optimized by adjusting the sequence of the other pitches to the sequence of the base pitches.

An adjustment to other desired tire properties, such as, e.g., uniform abrasion, can be facilitated in that the number of other pitches in the different types of profile positive groups is between 2 and 5.

The circumferential area of the tread featuring the profile positive groups can thereby be composed exclusively of groups with at least two pitches. Depending on the profile design, it can further be advantageous if the circumferential area of the tread subdivided into profile positive groups also features individual base pitches composed of only a single pitch.

The tire/road noise can also be favorably influenced by selecting the ratio of the length of the shortest base pitch to the length of the longest base pitch to be greater than the corresponding ratio within the other pitches. A length ratio—the ratio of the length of the shortest base pitch to the length of the longest base pitch of between approximately 1:1.6 and approximately 1:2 has proven to be particularly advantageous thereby.

In this regard, it is also advantageous if the ratio of the length of the shortest other pitch to the length of the longest other pitch is between approximately 1:1.2 and approximately 1:1.6.

An optimization to other tire properties, such as, e.g., hydroplaning behavior or uniform abrasion, is facilitated by the measure of making the cross-grooves in the profile positive groups narrower than the grooves running diagonally.

To minimize the tire/road noise, it can further be advantageous to vary the width of the cross-grooves in the profile positive groups together with the length of the pitches in these groups.

The invention also provides for a vehicle pneumatic tire, in particular radial tire, with a tread that is composed of profile positives that are structured by grooves running diagonally in or over the central area and by cross-grooves, whereby the grooves running diagonally together with the profile positives form base pitches with at least two different circumferential lengths, which are arranged over the tire circumference according to a pitch sequence in a noise-optimized manner, wherein at least in one tread area running in the circumferential direction the base pitches are subdivided by the cross-grooves into at least two different profile positive groups that are divided into other pitches, whereby at least one type of profile positive groups features at least one pitch more than the other or another type of profile positive groups.

The other pitches may be arranged within their profile positive group according to a specific sequence.

The sequence of the other pitches within one type of profile positive group may be adjusted to the sequence of the other pitches within the same and/or another type of a profile positive group.

The sequence of the other pitches may be adjusted to the sequence of the base pitches.

The number of other pitches in the different types of profile positive groups may be between two and five.

The circumferential area of the tread featuring the profile positive groups may be composed exclusively of groups with at least two pitches.

The circumferential area of the tread subdivided into profile positive groups may be provided with base pitches that comprise only one pitch.

The ratio of the length of the shortest base pitch to the length of the longest base pitch may be greater than the corresponding ratio of the other pitches.

The ratio of the length of the shortest base pitch to the length of the longest base pitch may be from 1:1.6 to 1:2.

The ratio of the length of the shortest other pitch to the length of the longest other pitch may be 1:1.2 to 1:1.6.

The cross-grooves in the profile positive groups may be narrower than the grooves running diagonally.

The width of the cross-grooves in the profile positive groups may be varied together with the length of the pitches in these groups.

The profile positive groups may be block groups in a shoulder block row.

The grooves running diagonally may form a much larger angle with the circumferential direction of the tire at the tread edge than in the area of the center of the tread.

The invention also provides for a vehicle tire that includes a tread comprising a circumference, profile structures, and grooves. The grooves run at least one of generally diagonally into a central area of the tread and generally diagonally over a central area of the tread. The grooves and the profile structures form base pitches. The base pitches are arranged over the circumference and having a pitch sequence which minimized tire noise. At least two of the base pitches have different circumferential lengths. One of the at least two base pitches comprises at least one profile structure and another of the at least two base pitches comprises at least two profile structures separated by at least one cross-groove.

The vehicle tire may be a pneumatic radial tire. The one of the at least two base pitches may comprise at least two profile structures subdivided by at least one cross-groove and the another of the at least two base pitches may comprise at least three profile structures subdivided by at least two cross-grooves. The profile structures may form an outer surface of the tread. The base pitches may be arranged according to a specific sequence. The profile structures in the another of the at least two base pitches may be arranged according to a specific sequence. The at least one profile structure in the one of the at least two base pitches and the at least two profile structures in the another of the at least two base pitches may be arranged with different specific sequences.

The one of the at least two base pitches may comprise at least two profile structures having different circumferential lengths subdivided by at least one cross-groove and the another of the at least two base pitches may comprise at least three profile structures having different circumferential lengths subdivided by at least two cross-grooves.

The one of the at least two base pitches may comprise first and second profile structures subdivided by at least one cross-groove and the another of the at least two base pitches may comprise third, fourth and fifth profile structures subdivided by at least two cross-grooves. The first and second profile structures may have different circumferential lengths. The first and second profile structures may have the same circumferential lengths. The first and third profile structures may have the same circumferential lengths. The first and fourth profile structures may have the same circumferential lengths. The first and fifth profile structures may have the same circumferential lengths. The second and third profile structures may have the same circumferential lengths. The second and fourth profile structures may have the same circumferential lengths. The second and fifth profile structures may have the same circumferential lengths. The third and fourth profile structures may have the same circumferential lengths. The third and fifth profile structures may have the same circumferential lengths. The fourth and fifth profile structures may have the same circumferential lengths. The first, second, third, fourth and fifth profile structures may have the same circumferential lengths. The first, second, third, fourth and fifth profile structures may have different circumferential lengths. The third, fourth and fifth profile structures may have different circumferential lengths. At least two of the first, second, third, fourth and fifth profile structures may have the same circumferential lengths. At least two of the first, second, third, fourth and fifth profile structures may have different circumferential lengths.

Each of the base pitches may comprise between two profile structures and five profile structures. Each of the base pitches may comprise at least two profile structures. Each of the base pitches may comprise the same number of profile structures. Each of the base pitches may have two profile structures. Each of the base pitches may have three profile structures. Each of the base pitches may have four profile structures. Each of the base pitches may have five profile structures.

One of the profile structures is the shortest of the profile structures in circumferential length and one of the profile structures is the longest of the profile structures in circumferential length, wherein a ratio of the circumferential length of the shortest profile structure to the circumferential length of the longest profile structure may be between approximately 1:1.6 and approximately 1:2. The ratio may be between approximately 1:1.2 and approximately 1:1.6.

The at least one cross-groove may be narrower in width than at least one of the grooves.

The one of the at least two base pitches may comprise first and second profile structures subdivided by a first cross-groove and the another of the at least two base pitches may comprise third, fourth and fifth profile structures subdivided by two second cross-grooves. A width of the first cross-groove may be different than a width of at least one of the two second cross-grooves. A width of the first cross-groove may be different than a width of each of the two second cross-grooves.

Each of the profile structures may be arranged in a circumferential row. The circumferential row may be arranged in a shoulder of the tread. The tread may further comprise at least one tread edge and wherein the grooves extend from the central area to the at least one tread edge. The grooves may have greater curvature in the central area than in an area of the at least one tread edge. The grooves may be oriented at a first angle, relative to a circumferential direction, in the central area and at a second angle, relative to the circumferential direction, in an area of the at least one tread edge, and the first angle may be different from the second angle. The grooves may be oriented at a first angle, relative to a circumferential direction, in the central area and at a second angle, relative to the circumferential direction, in an area of the at least one tread edge, and the first angle may be less than the second angle. The grooves may be oriented at a first angle, relative to a circumferential direction, in the central area and at a second angle, relative to the circumferential direction, in an area of the at least one tread edge, the first angle may be less approximately 45 degrees and the second angle may be greater than approximately 45 degrees.

The invention also provides for a method of making the tire described above wherein the method comprises forming the tread with the profile structures and the grooves, arranging the base pitches sequentially over an entire circumferential area in a pitch sequence that minimized tire noise, ensuring that at least two of the base pitches with different circumferential lengths, providing one of the at least two base pitches with at least one profile structure, and providing another of the at least two base pitches with at least two profile structures separated by at least one cross-groove.

The invention also provides for a vehicle pneumatic tire which comprises a tread including a circumference, profile structures, and grooves. The grooves extend from a central area of the tread to at least one tread edge and have greater curvature in the central area than in an area of the at least one tread edge. The grooves and the profile structures form base pitches. The base pitches are sequentially arranged over an entire circumferential area and having a pitch sequence which minimized tire noise. At least two of the base pitches have different circumferential lengths. One of the at least two base pitches comprises at least one profile structure and another of the at least two base pitches comprises at least two profile structures separated by at least one cross-groove.

The one of the at least two base pitches may comprise at least two profile structures subdivided by at least one cross-groove and the another of the at least two base pitches may comprise at least three profile structures subdivided by at least two cross-grooves. The one of the at least two base pitches may comprise at least two profile structures having different circumferential lengths subdivided by at least one cross-groove and the another of the at least two base pitches may comprise at least three profile structures having different circumferential lengths subdivided by at least two cross-grooves. The one of the at least two base pitches may comprise first and second profile structures subdivided by at least one cross-groove and the another of the at least two base pitches may comprise third, fourth and fifth profile structures subdivided by at least two cross-grooves. The first and second profile structures may have different circumferential lengths. The first and second profile structures may have the same circumferential lengths. The first and third profile structures may have the same circumferential lengths. The first and fourth profile structures may have the same circumferential lengths. The first and fifth profile structures may have the same circumferential lengths. The second and third profile structures may have the same circumferential lengths. The second and fourth profile structures may have the same circumferential lengths. The second and fifth profile structures may have the same circumferential lengths. The third and fourth profile structures may have the same circumferential lengths. The third and fifth profile structures may have the same circumferential lengths. The fourth and fifth profile structures may have the same circumferential lengths. The first, second, third, fourth and fifth profile structures may have the same circumferential lengths. The first, second, third, fourth and fifth profile structures may have different circumferential lengths. The third, fourth and fifth profile structures may have different circumferential lengths. At least two of the first, second, third, fourth and fifth profile structures may have the same circumferential lengths. At least two of the first, second, third, fourth and fifth profile structures may have different circumferential lengths. Each of the base pitches may comprise between two profile structures and five profile structures. Each of the base pitches may comprise at least two profile structures. Each of the base pitches may comprise the same number of profile structures.

The invention also provides for a method of making the tire described above wherein the method comprises forming the tread with the profile structures and the grooves, arranging the base pitches sequentially over an entire circumferential area in a pitch sequence that minimized tire noise, ensuring that at least two of the base pitches with different circumferential lengths, providing one of the at least two base pitches with at least one profile structure, and providing another of the at least two base pitches with at least two profile structures separated by at least one cross-groove.

The invention also provides for a vehicle pneumatic tire which comprises a tread comprising a central area having a central circumferential groove, profile structures arranged on opposite sides of the central circumferential groove, tread edges, and grooves. The grooves extend from the central circumferential groove to each of the tread edges, whereby oppositely extending grooves form V-shaped grooves which extend to the tread edges. Each of the grooves having greater curvature in the central area than in an area of the tread edges. The grooves and the profile structures are arranged on each side of the circumferential groove forming base pitches. Each base pitch has one groove and at least one profile structure. The base pitches are sequentially arranged over an entire circumferential surface of the tread and having a pitch sequence which minimized tire noise. The base pitches comprise first base pitches and second base pitches, wherein the first and second base pitches have different circumferential lengths. The first base pitches comprise at least one profile structure. The second base pitches comprise at least two profile structures separated by at least one cross-groove.

Each of the first base pitches may comprise at least two profile structures subdivided by at least one cross-groove and each of the second base pitches may comprise at least three profile structures subdivided by at least two cross-grooves. The base pitches may further comprise third base pitches, wherein the first, second and third base pitches have different circumferential lengths. Each of the third base pitches may comprise at least three profile structures subdivided by at least two cross-grooves. The tire may further comprise first and second circumferential grooves arranged on opposite sides of the central circumferential groove and a plurality of pocket grooves opening out at the first and second circumferential grooves.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

The only FIGURE is a diagrammatic representation of a partial development of a tread of a vehicle pneumatic tire.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The FIGURE shows by way of example an embodiment of a tread for a passenger vehicle tire, in particular a radial tire. The tread features central block rows 1 on each side of a central circumferential groove 5 running in the circumferential direction, which central block rows are respectively separated from shoulder block rows 2 by wide circumferential grooves 4 likewise running in the circumferential direction. Grooves 3 are characteristic of the tread and its division into individual blocks in the block rows 1, 2, which grooves 3 run in each tread half beginning at the central circumferential groove 5 into the tread edge areas and end outside the tread width B, which corresponds to the shuffle width of the tire. The grooves 3 that thus run continuously from the tread center to the tread edges are at least for most of their extension orientated and/or curved more to the circumferential direction than to the crosswise direction in that area in which they divide the blocks 10 of the central block rows 1 from one another, so that the angle they form with the circumferential direction is a maximum of approximately 45°. The sections of the grooves 3 running in the shoulder block rows 2 are orientated and/or curved more in the crosswise direction of the tread than in the circumferential direction, so that the angle the grooves 3 form here with the circumferential direction is >(greater than or equal to) approximately 45°, in particular can be much more than approximately 45°. In the shoulder block rows 2 the grooves 3 separate the block rows 2 into block groups 6 with individual blocks 6a, which will be discussed in more detail later.

Through the shape of the grooves 3 which becomes flatter (i.e., less curved) towards the tread edges, the shortest mutual spacing of grooves 3 that are adjacent in the circumferential direction is much smaller in the center of the tread than at the tread edges.

As is usual with treads, the tread shown is composed of profile steps, usually called pitches, in rows next to one another or one after the other in the circumferential direction. As is known, the division of treads into pitches with different circumferential lengths serves the purpose of minimizing or optimizing the tire/road noise in order to distribute or allow to occur the audible frequencies arising during the rolling of the tire such that they are as little disruptive as possible to the human ear.

In the embodiment shown in the FIGURE the tread is composed of base pitches L, M2, M1, K with four different lengths I_{L}, I_{M2}, I_{M1}, I_{K}, whereby I_{L}>I_{M2}>I_{M1}>I_{K}. Each pitch, L, M2, M1, K, comprises one of the grooves 3 and the profile structures running or provided up to the next groove 3. In the embodiment shown, they are and/or include per tread surface one block 10 from one of the central block rows 1 and one block group 6 from the shoulder block row 2.

In the embodiment shown in the FIGURE the ratio of the circumferential lengths I_{L}, I_{M2}, I_{M1}, I_{K} of the base pitches is such that I_{K}:I_{M1}:I_{M2}:I_{L}=1:1.18:1.38:1.69. In a pitch K of the length ¹K, which is the pitch with the smallest provided circumferential length, the associated block 10 in the central block row 1 is not structured further, whereby any narrow sipes and the like in the profile structures are not shown at all for a better overview. However, in a block 10 of the central block row 1 with which a pitch of length I_{L} is associated, starting from the circumferential groove 4, a pocket groove 7 is provided extending into and to about the center of the respective block 10, which pocket groove 7 approximately divides this block 10 (in e.g., half or two parts) and at least essentially features the orientation of the grooves 3. A division is thus made in those blocks 10 of the central block rows that feature a large circumferential extension (i.e., blocks in pitches L), which division has a favorable impact on both the tire/road noise and the abrasion of the tread.

A similar subdivision or partitioning is also present in the shoulder block rows 2, in that the above-mentioned block groups 6 are provided there which in the shown embodiment comprise either two or three blocks 6a. Embodiments are also possible in which up to approximately five blocks are present in one block group. According to the invention, the blocks 6a are now constituents of further pitches L_{B}, M_{B}, K_{B} of different circumferential lengths b_{L}, b_{M} and b_{K}, whereby b_{L}>b_{M}>b_{K}. Within a block group 6, the blocks 6a are separated from one another by cross-grooves 8 that are narrower, in particular much narrower, than the grooves 3. The orientation and the shape of the cross-grooves 8 generally correspond to those of the grooves 3. In other embodiments of treads, the cross-grooves associated with a block group can also feature the width of the grooves 3 running between the block grooves or even be somewhat wider. The disclosed embodiment shows cross-grooves 8 of essentially identical width. However, the invention also contemplates varying the width of the cross-grooves 8 with the circumferential extension of the blocks 6a, in particular to assign wider cross-grooves 8 to blocks 6a with greater circumferential length than to the blocks with lesser circumferential length. In any case the cross-grooves 8 are wider than socalled sipes 7 and can feature a minimum width of approximately 1.5 mm.

The pitches L_{B}, M_{B} and K_{B} are each composed of one block 6a and a groove 8 or 3 adjacent to it. If, for instance, a groove 3 belongs to a pitch K_{B}, the circumferential length of the block 6a is somewhat smaller due to the greater width of the groove 3.

In a base pitch L with the greatest circumferential length I_{L}, in the embodiment shown, a block group 6 is composed of three blocks 6a, in all other base pitches M2, M1, K, a block group 6 is composed respectively of two blocks 6a. The embodiment can thereby also be selected such that only a single block 6a is provided in a base pitch K, with the smallest circumferential length I_{K} and/or the number of the blocks 6a in the block group 6 can also be three in the base pitches M1, M2 of medium length I_{M1}, I_{M2}. Of course, how the arrangement is made and how favorable it is also depends, i.e., on how the length ratio of the base pitches L, M2, M1 and K to one another is selected.

The pitch lengths b_{L}, b_{M}, b_{K} of the pitches L_{B}, M_{B}, K_{B} of the block groups 6 are correspondingly adjusted to the lengths of the base pitches L, M2, M1, K, in order to be able to compose all base pitches L, M2, M1, K of the three further pitches L_{B}, M_{B}, K_{B} in the shoulder block rows 2. In the embodiment shown, the shortest pitch K_{B} has the relative length of approximately 0.5, the medium pitch M_{B} has the relative length of approximately 0.59 and the longest pitch L_{B} has the relative length of approximately 0.69. Accordingly, a base pitch K of the length I_{K} can be composed of two further pitches K_{B} of the length b_{K}, a base pitch M1 of the length I_{M1} is composed of two pitches M_{B} of length b_{M}, a medium base pitch M2 of length I_{M2} is composed of two pitches L_{B} of length b_{L}. The base pitch L with the greatest length I_{L} can be composed, e.g., of two pitches K_{B} of length b_{K} and one pitch L_{B} of length b_{L}

Further exemplary embodiments are summarized in the table below, whereby the base pitches are given in the left column and the other pitches are given in the right column. The figures in parentheses give the relative lengths in each case. The third column gives the length ratio of the other pitches.

| | | Length Ratios |
|---|---|---|
| Base | | of the |
| Pitches | Other Pitches | Other Pitches |
| K(1) | K_{B} K_{B}(.5 .5) | 1:1.2:1.4 |
| M(1.4) | L_{B} L_{B} (.7 .7) | |
| L(1.8) | M_{B}M_{B} M_{B}(.6 .6 .6) or | |
| | K_{B} M_{B} L_{B} (.5 .6 .7) and other | |
| | sequences | |
| K(1) | K_{B} K_{B}(.5 .5) | |
| M1(1.2) | M_{B} M_{B} (.6 .6) or L_{B}M_{B} | |
| M2(1.4) | L_{B} L_{B}(.7 .7) | 1:1.2:1.4 |
| L(1.6) | K_{B} K_{B} M_{B} (.5 .5 .6) and other | |
| | sequences | |
| K(1) | K_{B} K_{B}(.5 .5) | 1:1.2:1.4 |
| M1(1.3) | M_{B} L_{B} (.6 .7) or L_{B} M_{B} | |
| M2(1.6) | K_{B}K_{B} M_{B}(.5 .5 .6) and other | |
| L(2) | sequences | |
| | M_{B}L_{B} L_{B}(.6 .7. .7) and other | |
| | sequences | |
| | or K_{B}K_{B} K_{B}K_{B} (.5 .5 .5 .5) | |
| K(1) | L_{B} (1) | 1:1.21:1.43 |
| L(1.55) | M_{B} K_{B} (.85 .7) and other sequences | |
| K(1) | L_{B} (1) | 1:1.43 |
| M(1.4) | K_{B} K_{B} (.7 .7) | |
| L(1.7) | K_{B} L_{B}(.7 1) and other sequences | 1:1.21:1.43 |
| | or M_{B}M_{B} (.85 .85) | |
| K(1) | K_{B} K_{B}(.5 .5) | 1:1.354 |
| M(1.354) | L_{B} L_{B} (.677 .677) | |
| L(1.677) | K_{B}K_{B} L_{B}(.5 .5 .677) and other | |
| | sequences | |

According to the invention in the shoulder block rows 2, the pitches L_{B}, M_{B}, K_{B} of different circumferential lengths b_{L}, b_{M}, b_{K} within the base pitches L, M2, M1, K are therefore distributed or arranged as favorably as possible.

In a tread embodied according to the invention, the profile structures in the shoulder block rows are thus coupled and adjusted to one another optically and geometrically. The division according to the invention of the block groups into pitches permits further variants of the selection of pitch sequences and pitch lengths, so that the tire/road noise can be better optimized and at the same time other tire properties, e.g., uniform abrasion, etc. can also be taken into account much more easily than was possible with the hitherto known conventional optimizations by means of pitch geometries.

The division of treads into base pitches and other pitches can also be made without the presence of circumferential grooves in the tread side areas, whereby no circumferential groove needs to be arranged in the central area, either. The relevant division need only be made by grooves running diagonally in connection with other cross-grooves that end in a pocket groove-like manner. A tread embodied in this manner thus no longer has a “real” block structure, but a profile positive structure marked by grooves running crosswise and/or diagonally. Depending on the division made and the selected shape of the grooves running diagonally, the or a tread area that is divided into further pitches can also be provided in the central area of the tread. The pitch borders do not have to run in the manner shown, either, they can also cross profile positives or blocks.

The number of the base pitches of different circumferential lengths is at least approximately two and in particular up to approximately five, but can also be higher. Depending on the number of the base pitches and the other profile design, the number of other pitches of different lengths will be between approximately two and approximately five.

The ratio of the lengths of the shortest base pitch to the length of the longest base pitch is preferably from between approximately 1:1.6 and approximately 1:2. This ratio of between approximately 1:1.2 and approximately 1:1.6 is selected for the other pitches. In particular in a certain tread the ratio of the lengths of the shortest pitch to the longest pitch is greater for the base pitches than for the other pitches.

Tires embodied according to the invention can be both passenger vehicle and commercial vehicle and other vehicle treads.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A vehicle tire, comprising:
a tread comprising a circumference, profile structures, and grooves;
the grooves running generally diagonally into a central area of the tread;
the grooves and the profile structures forming base pitches;
the base pitches being circumferentially arranged in at least one tread area and having a pitch sequence arranged to minimize tire noise; and
at least two of the base pitches having different circumferential lengths;
one of the at least two base pitches comprising at least one profile structure; and
another of the at least two base pitches comprising at least two profile structures separated by at least one cross-groove.

2. The tire of claim 1, wherein the vehicle tire is a pneumatic radial tire.

3. The tire of claim 1, wherein the one of the at least two base pitches comprises at least two profile structures subdivided by at least one cross-groove and the another of the at least two base pitches comprises at least three profile structures subdivided by at least two cross-grooves.

4. The tire of claim 1, wherein the profile structures form an outer surface of the tread.

5. The tire of claim 1, wherein the base pitches are arranged according to a specific sequence.

6. The tire of claim 1, wherein the profile structures in the another of the at least two base pitches are arranged according to a specific sequence.

7. The tire of claim 1, wherein the at least one profile structure in the one of the at least two base pitches and the at least two profile structures in the another of the at least two base pitches are arranged with different specific sequences.

8. The tire of claim 1, wherein the one of the at least two base pitches comprises at least two profile structures having different circumferential lengths subdivided by at least one cross-groove and the another of the at least two base pitches comprises at least three profile structures having different circumferential lengths subdivided by at least two cross-grooves.

9. The tire of claim 1, wherein the one of the at least two base pitches comprises first and second profile structures subdivided by at least one cross-groove and the another of the at least two base pitches comprises third, fourth and fifth profile structures subdivided by at least two cross-grooves.

10. The tire of claim 9, wherein the first and second profile structures have different circumferential lengths.

11. The tire of claim 9, wherein the first and second profile structures have the same circumferential lengths.

12. The tire of claim 9, wherein the first and at least one of the third, fourth and fifth profile structures have the same circumferential lengths.

13. The tire of claim 9, wherein the second and at least one of the third, fourth and fifth profile structures have the same circumferential lengths.

14. The tire of claim 9, wherein at least two of the third, fourth and fifth profile structures have the same circumferential lengths.

15. The tire of claim 9, wherein the first, second, third, fourth and fifth profile structures have the same circumferential lengths.

16. The tire of claim 9, wherein the first, second, third, fourth and fifth profile structures have different circumferential lengths.

17. The tire of claim 9, wherein the third, fourth and fifth profile structures have different circumferential lengths.

18. The tire of claim 9, wherein at least two of the first, second, third, fourth and fifth profile structures have the same circumferential lengths.

19. The tire of claim 9, wherein at least two of the first, second, third, fourth and fifth profile structures have different circumferential lengths.

20. The tire of claim 1, wherein each of the base pitches comprises between two profile structures and five profile structures.

21. The tire of claim 1, wherein each of the base pitches comprises at least two profile structures.

22. The tire of claim 1, wherein each of the base pitches comprises the same number of profile structures.

23. The tire of claim 1, wherein each of the base pitches has two profile structures.

24. The tire of claim 1, wherein each of the base pitches has three profile structures.

25. The tire of claim 1, wherein each of the base pitches has four profile structures.

26. The tire of claim 1, wherein each of the base pitches has five profile structures.

27. The tire of claim 1, wherein one of the profile structures is the shortest of the profile structures in circumferential length and wherein one of the profile structures is the longest of the profile structures in circumferential length, and wherein a ratio of the circumferential length of the shortest profile structure to the circumferential length of the longest profile structure is between approximately 1:1.2 and approximately 1:2.

28. The tire of claim 27, wherein the ratio is between approximately 1:1.2 and approximately 1:1.6.

29. The tire of claim 27, wherein the ratio is between approximately 1:1.6 and approximately 1:2.

30. The tire of claim 1, wherein the at least one cross-groove is narrower in width than at least one of the grooves.

31. The tire of claim 1, wherein each at least one cross-groove is narrower in width than at least one of the grooves.

32. The tire of claim 1, wherein the one of the at least two base pitches comprises first and second profile structures subdivided by a first cross-groove and the another of the at least two base pitches comprises third, fourth and fifth profile structures subdivided by two second cross-grooves.

33. The tire of claim 32, wherein a width of the first cross-groove is different than a width of at least one of the two second cross-grooves.

34. The tire of claim 32, wherein a width of the first cross-groove is different than a width of each of the two second cross-grooves.

35. The tire of claim 1, wherein each of the profile structures is arranged in a circumferential row.

36. The tire of claim 35, wherein the circumferential row is arranged in a shoulder of the tread.

37. The tire of claim 1, wherein the tread further comprises at least one tread edge and wherein the grooves extend from the central area to the at least one tread edge.

38. The tire of claim 37, wherein the grooves have greater curvature in the central area than in an area of the at least one tread edge.

39. The tire of claim 1, wherein the grooves are oriented at a first angle, relative to a circumferential direction, in the central area and at a second angle, relative to the circumferential direction, in an area of the at least one tread edge, and wherein the first angle is different from the second angle.

40. The tire of claim 39, wherein the first angle is less than the second angle.

41. The tire of claim 40, wherein the first angle is less approximately 45 degrees and the second angle is greater than approximately 45 degrees.

42. A method of making the tire of claim 1, the method comprising:
forming the tread with the profile structures and the grooves;
arranging the base pitches sequentially over an entire circumferential area in a pitch sequence to minimize tire noise;
forming at least two of the base pitches with different circumferential lengths;
providing one of the at least two base pitches with at least one profile structure; and
providing another of the at least two base pitches with at least two profile structures separated by at least one cross-groove.

43. A vehicle pneumatic tire, comprising:
a tread comprising a circumference, profile structures, and grooves;
the grooves extending from a central area of the tread to at least one tread edge and having greater curvature in the central area than in an area of the at least one tread edge;
the grooves and the profile structures forming base pitches;
the base pitches being sequentially arranged over an entire circumferential area and having a pitch sequence which minimizes tire noise; and
at least two of the base pitches having different circumferential lengths;
one of the at least two base pitches comprising at least one profile structure; and
another of the at least two base pitches comprising at least two profile structures separated by at least one cross-groove.

44. The tire of claim 43, wherein the one of the at least two base pitches comprises at least two profile structures subdivided by at least one cross-groove and the another of the at least two base pitches comprises at least three profile structures subdivided by at least two cross-grooves.

45. The tire of claim 43, wherein the one of the at least two base pitches comprises at least two profile structures having different circumferential lengths subdivided by at least one cross-groove and the another of the at least two base pitches comprises at least three profile structures having different circumferential lengths subdivided by at least two cross-grooves.

46. The tire of claim 43, wherein the one of the at least two base pitches comprises first and second profile structures subdivided by at least one cross-groove and the another of the at least two base pitches comprises third, fourth and fifth profile structures subdivided by at least two cross-grooves.

47. The tire of claim 46, wherein the first and second profile structures have different circumferential lengths.

48. The tire of claim 46, wherein the first and second profile structures have the same circumferential lengths.

49. The tire of claim 46, wherein the first and at least one of third, fourth and fifth profile structures have the same circumferential lengths.

50. The tire of claim 46, wherein the second and at least one of the third, fourth and fifth profile structures have the same circumferential lengths.

51. The tire of claim 46, wherein at least two of the third, fourth and fifth profile structures have the same circumferential lengths.

52. The tire of claim 46, wherein the first, second, third, fourth and fifth profile structures have the same circumferential lengths.

53. The tire of claim 46, wherein the first, second, third, fourth and fifth profile structures have different circumferential lengths.

54. The tire of claim 46, wherein the third, fourth and fifth profile structures have different circumferential lengths.

55. The tire of claim 46, wherein at least two of the first, second, third, fourth and fifth profile structures have the same circumferential lengths.

56. The tire of claim 46, wherein at least two of the first, second, third, fourth and fifth profile structures have different circumferential lengths.

57. The tire of claim 43, wherein each of the base pitches comprises between two profile structures and five profile structures.

58. The tire of claim 43, wherein each of the base pitches comprises at least two profile structures.

59. The tire of claim 43, wherein each of the base pitches comprises the same number of profile structures.

60. A method of making the tire of claim 43, the method comprising:
forming the tread with the profile structures and the grooves;
arranging the base pitches sequentially over an entire circumferential area in a pitch sequence that minimizes tire noise;
forming at least two of the base pitches with different circumferential lengths;
providing one of the at least two base pitches with at least one profile structure; and
providing another of the at least two base pitches with at least two profile structures separated by at least one cross-groove.

61. A vehicle pneumatic tire, comprising:
a tread comprising a central area having a central circumferential groove, profile structures arranged on opposite sides of the central circumferential groove, tread edges, and grooves;
the grooves extending from the central circumferential groove to each of the tread edges, whereby oppositely extending grooves form V-shaped grooves which extend to the tread edges;
each of the grooves having greater curvature in the central area than in an area of the tread edges;
the grooves and the profile structures being arranged on each side of the central circumferential groove forming base pitches;
each base pitch having one groove and at least one profile structure;
the base pitches being sequentially arranged over an entire circumferential surface of the tread and having a pitch sequence which minimize tire noise;
the base pitches comprising first base pitches and second base pitches, wherein the first and second base pitches have different circumferential lengths;
the first base pitches comprising at least one profile structure; and
the second base pitches comprising at least two profile structures separated by at least one cross-groove.

62. The tire of claim 61, wherein each of the first base pitches comprises at least two profile structures subdivided by at least one cross-groove and wherein each of the second base pitches comprises at least three profile structures subdivided by at least two cross-grooves.

63. The tire of claim 61, wherein the base pitches further comprises third base pitches, wherein the first, second and third base pitches have different circumferential lengths.

64. The tire of claim 63, wherein each of the third base pitches comprises at least three profile structures subdivided by at least two cross-grooves.

65. The tire of claim 61, further comprising first and second circumferential grooves arranged on opposite sides of the central circumferential groove and a plurality of pocket grooves opening out at the first and second circumferential grooves.
